(19) United States
(12) Patent Application Publication
(10) Pub. No.: US 2014/0188502 A1
(43) Pub. Date: Jul. 3, 2014

(54) PRESCRIPTION SMART LABEL SYSTEM

(71) Applicants: Edmond Arthur Defrank, Northridge, CA (US); Nicolas Defrank, Northridge, CA (US); Antonio Defrank, Northridge, CA (US); Antonio Defrank, Northridge, CA (US); Allen Mark Jones, Imperial Beach, CA (US)

(72) Inventors: Edmond Arthur Defrank, Northridge, CA (US); Nicolas Defrank, Northridge, CA (US); Antonio Defrank, Northridge, CA (US); Antonio Defrank, Northridge, CA (US); Allen Mark Jones, Imperial Beach, CA (US)

(21) Appl. No.: 14/074,706

(22) Filed: Nov. 7, 2013

Related U.S. Application Data
(60) Provisional application No. 61/747,289, filed on Dec. 29, 2012.

(51) Int. Cl. G06F 19/00

(52) U.S. Cl. CPC G06F 19/3456
USPC 705/2; 347/224

(57) ABSTRACT

The embodiments disclose a prescription smart label system for tracking patient use of prescription medications to assist in medication treatment to monitor their progress toward recovery or health maintenance including a prescription smart label including a text section with prescription information, a smart label programmable memory device, one or more rechargeable battery systems, other digital devices and Wi-Fi direct near field communication transmitter used to transmit patient prescription use, a prescription smart label cap including one or more systems to remind patients of prescription use times and dosages, a prescription smart label bottle including one or more systems used to monitor the physical use of the patient prescription medication and monitor the contents of the prescription smart label bottle and a prescription smart label mobile application used to gather, record, store and transmit patient patient prescription use data.

### CROSS-REFERENCE TO RELATED APPLICATIONS

This application is based on U.S. Provisional Patent Application Ser. No. 61/747,289 filed Dec. 29, 2012, entitled “A PRESCRIPTION SMART LABEL BOTTLE AND CAP”, by Edmond Arthur DeFrank.

### BACKGROUND

Patients many times forget to take prescribed medications on time in accordance with their doctor's orders and the dosage written on the prescription bottle label. Particularly elderly or aged patients simply forget to take their medicine. The aging of the population forecast due to the large portion of “Baby Boomers” can aggravate the numbers of patients missing dosages. Medical providers are relying on the patients to monitor their own dosage as it is not financially feasible to hospitalize every person taking medication. A system is needed by which both the patient is reminded to take their medication and doctors can remotely monitor the proper use of the medicines they prescribed.

### BRIEF DESCRIPTION OF THE DRAWINGS

FIG. 1 shows for illustrative purposes only an example of a prescription smart label system of one embodiment.

FIG. 2A shows for illustrative purposes only an example of a light powered prescription smart label of one embodiment.

FIG. 2B shows for illustrative purposes only an example of a smart label programmable memory device of one embodiment.

FIG. 3 shows for illustrative purposes only an example of energy induction coils of one embodiment.

FIG. 4A shows for illustrative purposes only an example of a prescription smart label cap of one embodiment.

FIG. 4B shows for illustrative purposes only an example of a prescription smart label cap projector of one embodiment.

FIG. 4C shows for illustrative purposes only an example of a projected prescription reminder of one embodiment.

FIG. 4D shows for illustrative purposes only an example of a prescription smart label cap cross section view of one embodiment.

FIG. 4E shows for illustrative purposes only an example of a prescription smart label cap internal plan view of one embodiment.

FIG. 4F shows for illustrative purposes only an example of a cap strap connector of one embodiment.

FIG. 4G shows for illustrative purposes only an example of a prescription smart label flow chart schematic of one embodiment.

FIG. 5A shows for illustrative purposes only an example of a prescription smart label bottle of one embodiment.

FIG. 5B shows for illustrative purposes only an example of a flexible rechargeable flat battery recharging circuit of one embodiment.

FIG. 5C shows for illustrative purposes only an example of a med weight transducer of one embodiment.

FIG. 6A shows for illustrative purposes only an example of a cap ring connector of one embodiment.

FIG. 6B shows for illustrative purposes only an example of a cap ring connector and label guide of one embodiment.

FIG. 6C shows for illustrative purposes only an example of a label vertical guideline of one embodiment.

FIG. 7A shows for illustrative purposes only an example of a recharging tray of one embodiment.

FIG. 7B shows for illustrative purposes only an example of a prescription smart label bottle recharging tray of one embodiment.

FIG. 8A shows a block diagram of an overview flow chart of prescription smart label operations of one embodiment.

FIG. 8B shows a block diagram of an overview flow chart of prescription smart label communications of one embodiment.

FIG. 9 shows for illustrative purposes only an example of a pharmacy preparation of prescription smart label of one embodiment.

FIG. 10 shows for illustrative purposes only an example of a prescription smart label mobile application of one embodiment.

FIG. 11 shows for illustrative purposes only an example of an automatically locate prescription smart label bottle of one embodiment.

FIG. 12A shows for illustrative purposes only an example of a reusable prescription smart label of one embodiment.

FIG. 12B shows for illustrative purposes only an example of a recyclable prescription smart label of one embodiment.

FIG. 12C shows for illustrative purposes only an example of a label apparatus single label mode of one embodiment.

FIG. 13A shows for illustrative purposes only an example of a fabrication process of the prescription smart label cap of one embodiment.

FIG. 13B shows for illustrative purposes only an example of a cap covering cut away view of one embodiment.

FIG. 13C shows for illustrative purposes only an example of a prescription smart label cap molded of one embodiment.

FIG. 14A shows for illustrative purposes only an example of a fabricating the prescription smart label bottle of one embodiment.

FIG. 14B shows for illustrative purposes only an example of a bottom coil cover of one embodiment.

FIG. 14C shows for illustrative purposes only an example of a prescription smart label bottle molded of one embodiment.

FIG. 15 shows for illustrative purposes only an example of a prescription smart label mobile application gathering prescription data from a regular prescription label of one embodiment.

FIG. 16 shows for illustrative purposes only an example of a prescription smart label mobile application taking photos of regular prescription label to OCR to gather data of one embodiment.

FIG. 17A shows for illustrative purposes only an example of a prescription smart label mobile application taking photos of a timer cap to gather patient medication usage data of one embodiment.

FIG. 17B shows for illustrative purposes only an example of a prescription smart label mobile application taking photos of remaining pills to gather patient medication usage data of one embodiment.

### DETAILED DESCRIPTION OF THE INVENTION

In a following description, reference is made to the accompanying drawings, which form a part hereof, and in which is shown by way of illustration a specific example in which the invention may be practiced. It is to be understood that other embodiments may be utilized and structural changes may be made without departing from the scope of the present invention.

### General Overview:

It should be noted that the descriptions that follow, for example, in terms of a prescription smart label bottle and cap is described for illustrative purposes and the underlying system can apply to any number and multiple types of prescription labels, bottles or containers and caps or stoppers. In one embodiment, the bottle can be configured using one type of plastic or glass or other materials and the cap can be configured using another type of plastic or other materials. The prescription smart label can be configured to include flexible materials for printing of data and can be configured to include flexible materials for other features included in the prescription smart label using the present invention.

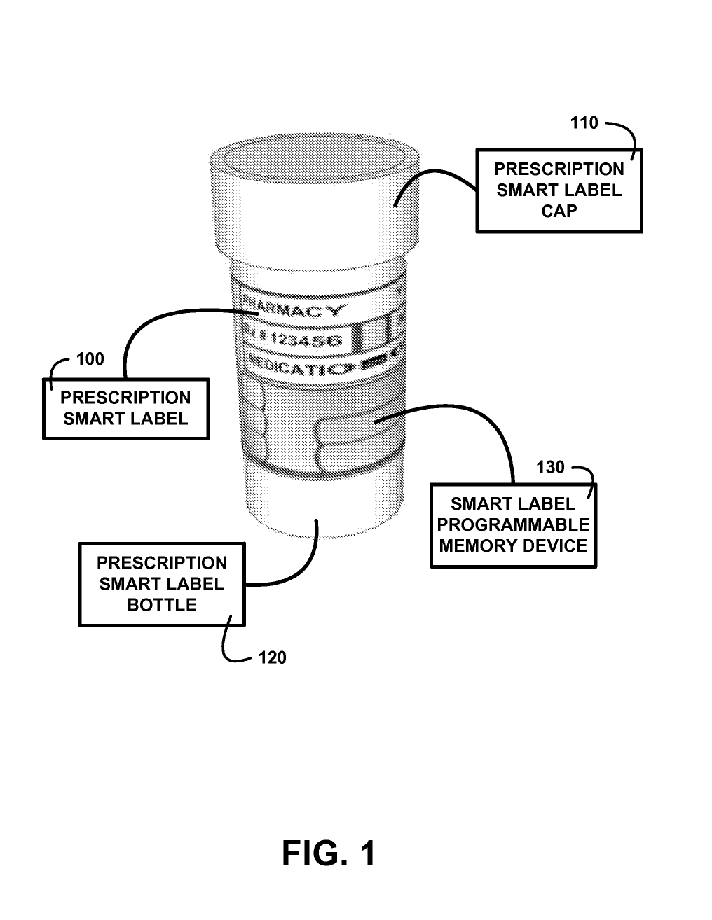

FIG. 1 shows for illustrative purposes only an example of a prescription smart label bottle and cap of one embodiment. FIG. 1 shows a prescription smart label 100 bottle and cap system including a prescription smart label 100, prescription smart label cap 110, a prescription smart label bottle 120, and a smart label programmable memory device 130. The prescription smart label 100 is affixed to a prescription smart label bottle 120 and the bottle is sealed using a prescription smart label cap 110. The prescription smart label 100 bottle and cap system monitors the frequency and volume of medication taken by a patient, provides multiple means of reminding a patient to take the medicine and automatically reports periodically to the prescribing doctor the patient's use of the medicine. It also sends a notice to the pharmacy that filled the prescription when the patient's supply is running low or is out.

The benefits of the prescription smart label 100 bottle and cap system are proper medication treatment for the patient to insure they benefit from the medicines they paid for or were paid for by health insurance or government funded programs including Medicare. The doctors and health providers benefit by getting automated and accurate updates on medication use by their patients to be able to monitor their progress toward recovery or health maintenance. The pharmacy benefits by having a means to anticipate refilling of prescriptions to better maintain a reasonable inventory to fill upcoming prescription refills of one embodiment.

### Detailed Description:

### Light Powered Prescription Smart Label:

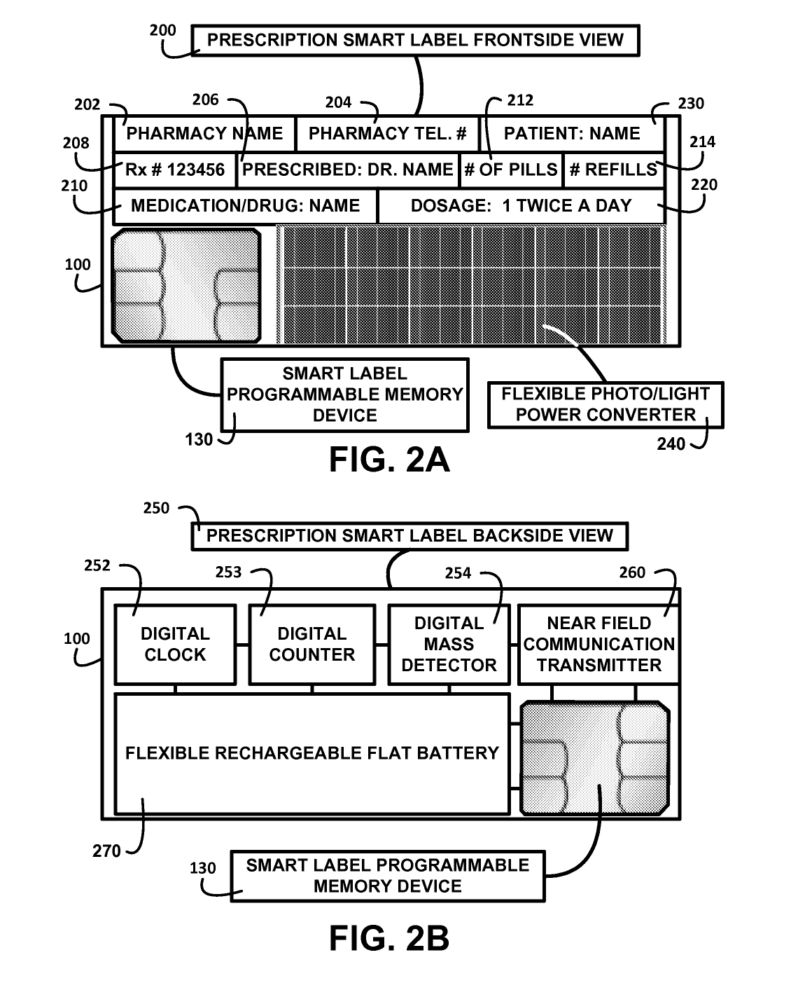

FIG. 2A shows for illustrative purposes only an example of a light powered prescription smart label of one embodiment. FIG. 2A shows a prescription smart label front side view 200 including a flexible photo/light power converter 240 for example a solar cell array, or a device for converting light of infrared (IR) and visible wavelengths into direct current and rectennas using long-wavelength light including microwaves and radio waves. The prescription smart label includes a smart label programmable memory device 130 to store information and data including printed data including a pharmacy name 202, pharmacy tel. # 204, patient: name 230, Rx # 123456 208, prescribed: Dr. name 206, # of pills 212, # refills 214, medication/drug: name 210 and dosage: 1 twice a day 220.

A patient can download the prescription smart label information and data stored onto a mobile device including a smart cell phone by pairing the mobile device with the prescription smart label 100. To pair the mobile device with the prescription smart label the patient will bring the mobile device in close proximity with the prescription smart label smart label programmable memory device 130 using near field communication (NFC) and Wi-Fi Direct. Once in close contact a patient starts triggering a “pairing” between them, using a button on one of the devices, or systems such as NFC of one embodiment.

### Smart Label Programmable Memory Device:

FIG. 2B shows for illustrative purposes only an example of a smart label programmable memory device of one embodiment. FIG. 2B shows a prescription smart label backside view 250 including a backside view of the smart label programmable memory device 130. The layered fabrication of the prescription smart label 100 includes on the back a flexible rechargeable flat battery 270, a digital clock device 252 to record when a patient takes medication, a digital counter device 253 to count and record the number of times the bottle is opened, a digital mass detector 254 to scan the volume and mass of the contents of the bottle and a near field communication transmitter 260 of one embodiment.

### Energy Induction Coils:

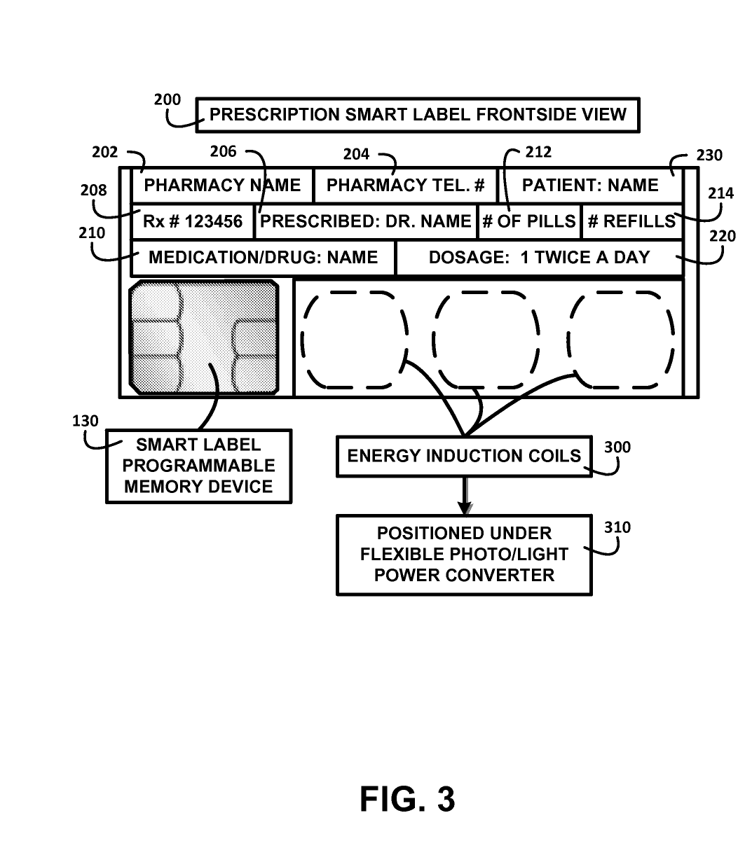

FIG. 3 shows for illustrative purposes only an example of an energy induction coils of one embodiment. FIG. 3 shows prescription smart label front side view 200 including energy induction coils 300 used to recharge the flexible rechargeable flat battery 270 of FIG. 2B. The energy induction coils 300 are positioned under the flexible photo/light power converter 240 of FIG. 2A. The smart label programmable memory device 130 is downloaded with patient information and prescription data at a pharmacy. The downloaded information and data includes pharmacy name 202 and/or logo, pharmacy tel. # 204, patient: name 230, Rx # 123456 208, prescribed: Dr. name 206, # of pills 212 of one embodiment.

### Prescription Smart Label Cap:

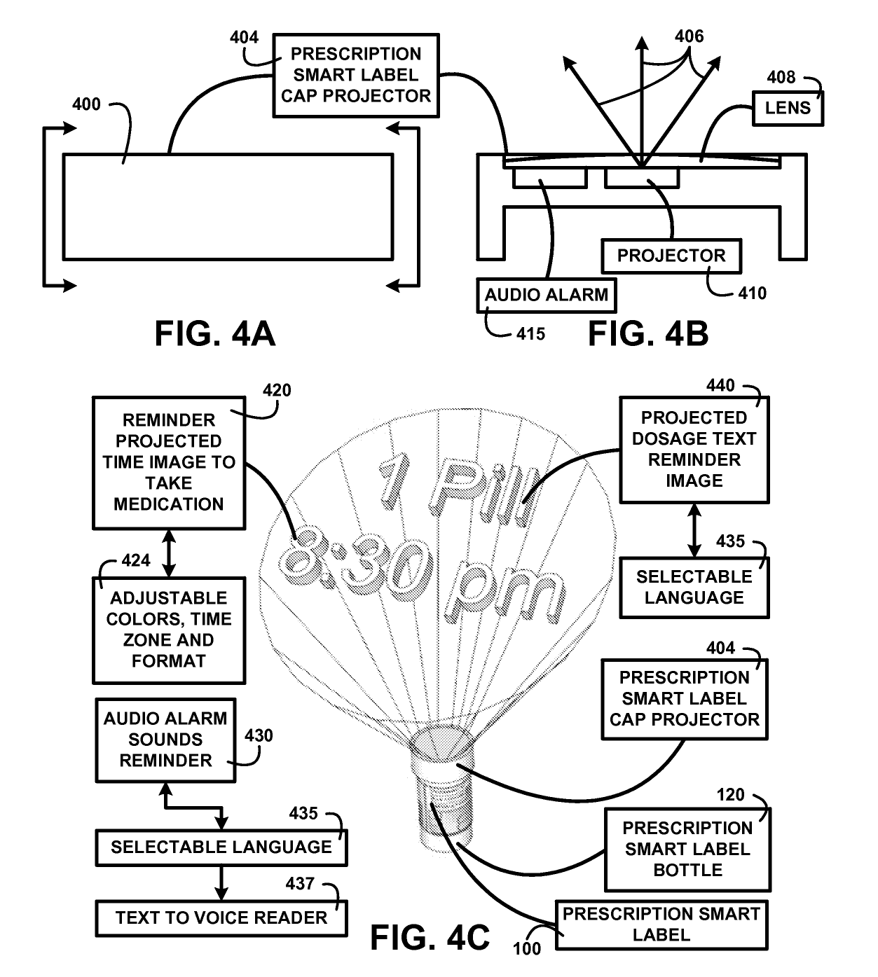

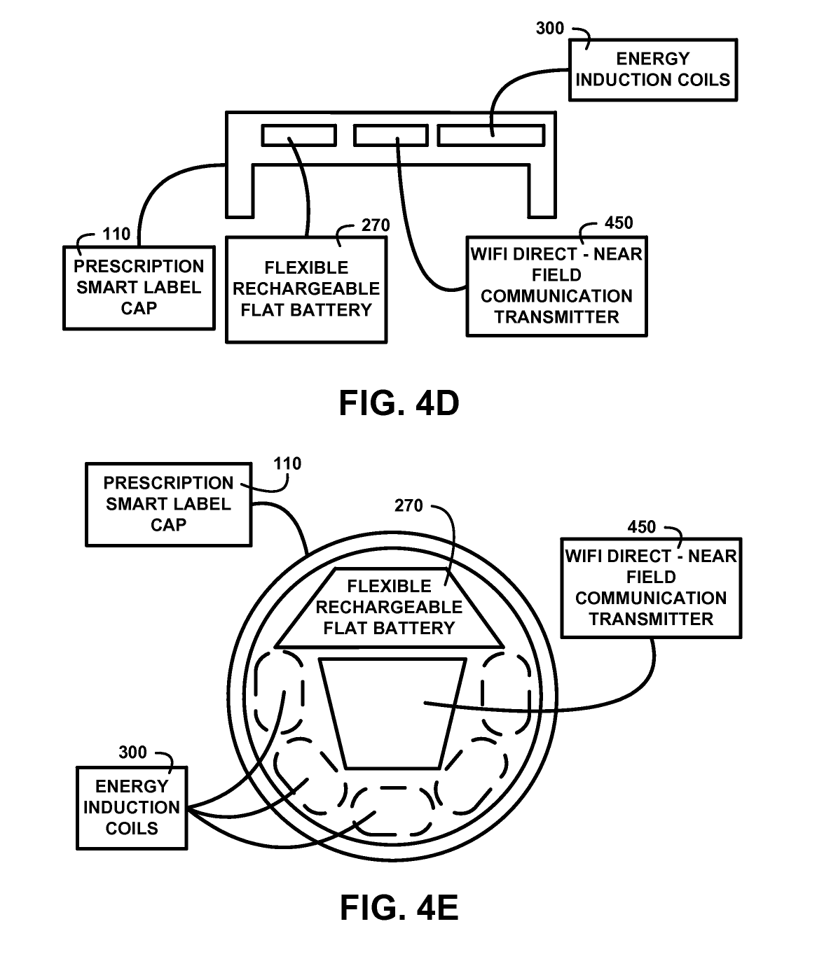

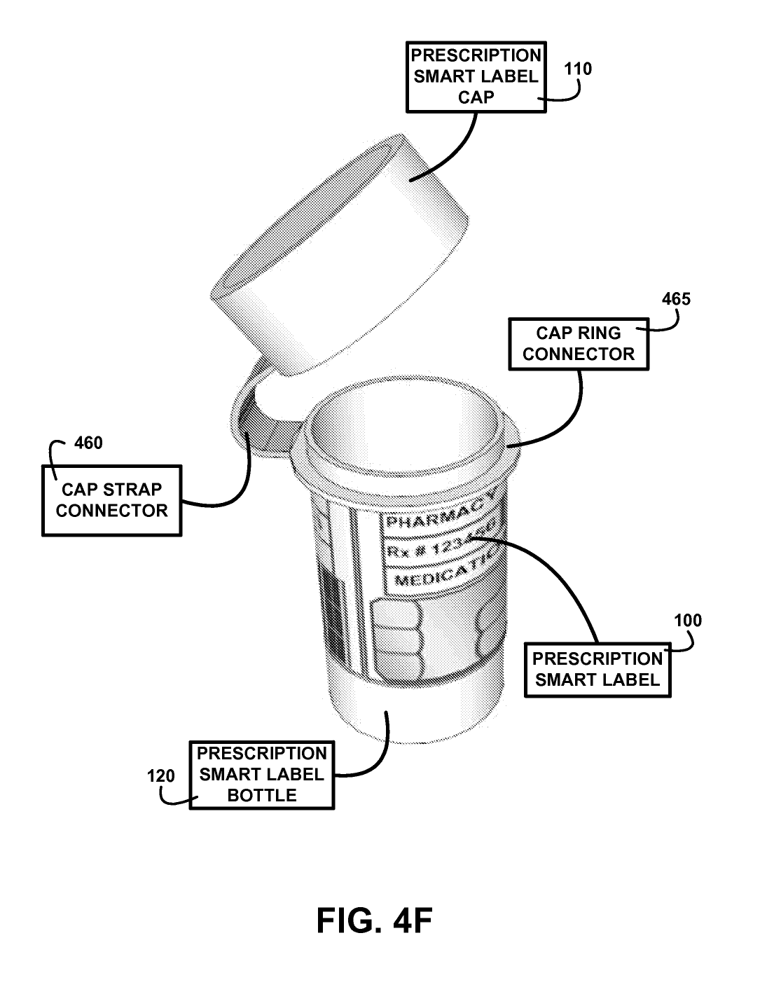

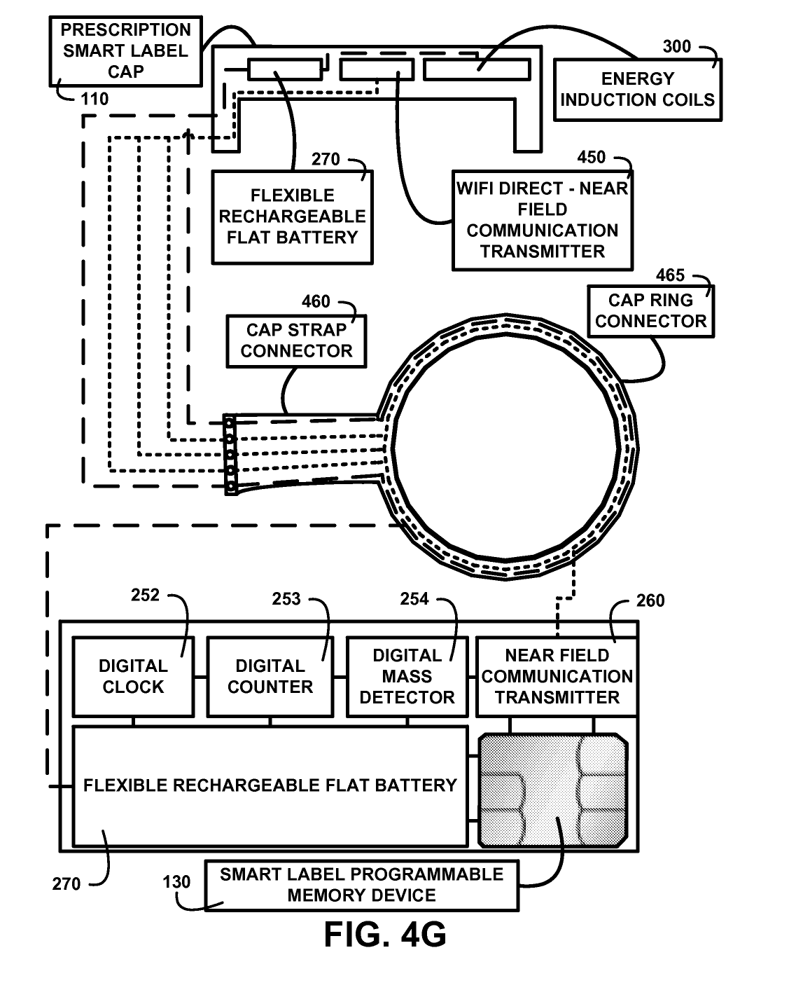

FIG. 4A shows for illustrative purposes only an example of a prescription smart label cap of one embodiment. FIG. 4A shows the prescription smart label cap 110 of FIG. 1 configured to include a prescription smart label cap projector 404 showing section lines for a cross section view in FIG. 4B of one embodiment.

### Prescription Smart Label Cap Prosector:

FIG. 4B shows for illustrative purposes only an example of a prescription smart label cap projector of one embodiment. FIG. 4B shows a prescription smart label cap projector 404 cross section view including a projector 410, lens 408 and audio alarm 415 of one embodiment.

### Projected Prescription Reminder:

FIG. 4C shows for illustrative purposes only an example of a projected prescription reminder of one embodiment. FIG. 4C shows the prescription smart label bottle 120, affixed prescription smart label 100 and the prescription smart label cap projector 404 creating a projected dosage text reminder image 440. The reminder projected time image to take medication 420 uses adjustable colors, time zone and format 424. The prescription smart label cap projector 404 includes the audio alarm sounds reminder 430 to the patient to take their medication of one embodiment.

The prescription smart label cap projector 404 is used to display a visual reminder of the time for the next patient dosage enabling a deaf patient a means to see a reminder. The color of the projected image is adjustable by the patient to draw their attention. The audio alarm 415 of FIG. 4B is beneficial for blind patients who might not be able to see the projected image or a text message. The audio alarm 415 of FIG. 4B includes an adjustable selection of alarm sounds and selectable language 435 settings. The audio alarm 415 of FIG. 4B includes a text to voice reader 437 to announce the time and dosage for the next medication period of one embodiment.

### Prescription Smart Label Cap Cross Section View:

FIG. 4D shows for illustrative purposes only an example of a prescription smart label cap cross section view of one embodiment. FIG. 4D shows a prescription smart label cap 110 cross section view that includes the energy induction coils 300 used to charge a flexible rechargeable flat battery 270. The battery powers a Wi-Fi direct—near field communication transmitter 450 used to broadcast reminders and locating information of one embodiment.

### Prescription Smart Label Cap Internal Plan View:

FIG. 4E shows for illustrative purposes only an example of a prescription smart label cap internal plan view of one embodiment. FIG. 4E shows a prescription smart label cap 110 internal plan view including the energy induction coils 300, flexible rechargeable flat battery 270 and Wi-Fi direct—near field communication transmitter 450 of one embodiment.

### Cap Strap Connector:

FIG. 4F shows for illustrative purposes only an example of a cap strap connector of one embodiment. FIG. 4F shows the prescription smart label bottle 120 with affixed prescription smart label 100. The prescription smart label cap 110 includes a cap strap connector 460 connecting the prescription smart label cap 110 to a cap ring connector 465 of one embodiment.

### Prescription Smart Label Flow Chart Schematic:

FIG. 4G shows for illustrative purposes only an example of a prescription smart label flow chart schematic of one embodiment. FIG. 4G shows a flow chart schematic back view of the prescription smart label including the smart label programmable memory device 130 and flexible rechargeable flat battery 270 used to conduct power through the cap ring connector 465 and cap strap connector 460 to the flexible rechargeable flat battery 270 in the prescription smart label cap 110 to power the Wi-Fi direct—near field communication transmitter 450. The digital clock 252, digital counter 253 and digital mass detector 254 track the times and information of patient use of the medication. The near field communication transmitter 260 can transmit directly or transmit through the prescription smart label cap 110 which can be recharged independently through the energy induction coils 300 location in the cap of one embodiment.

### Prescription Smart Label Bottle:

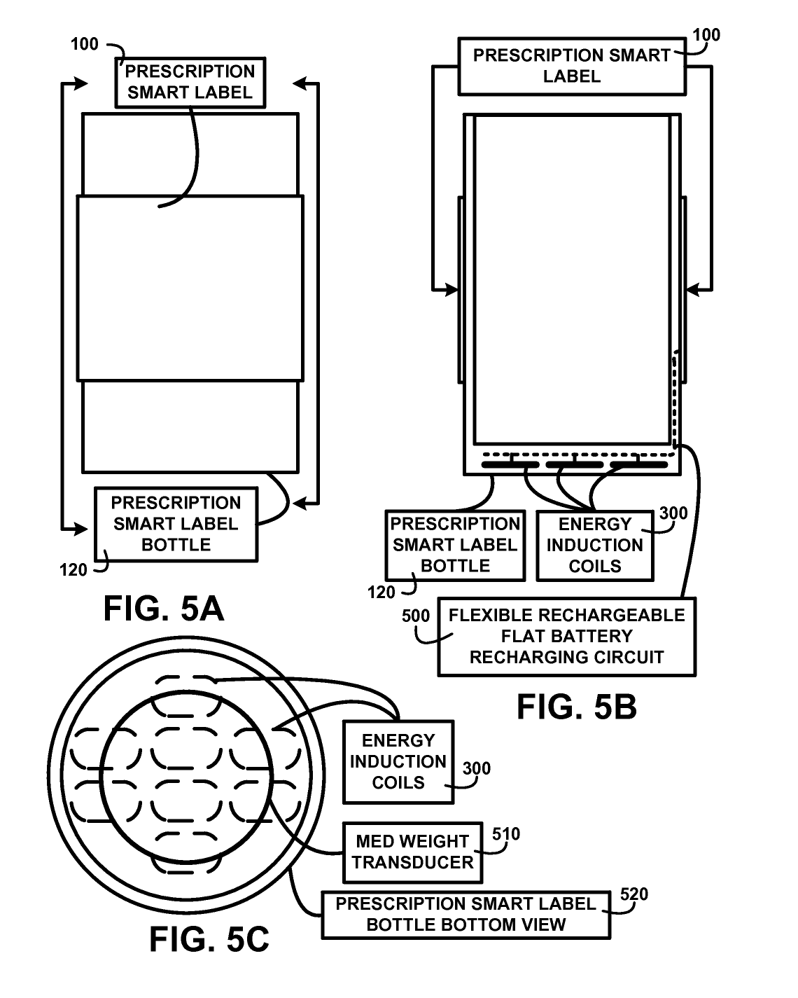

FIG. 5A shows for illustrative purposes only an example of a prescription smart label bottle of one embodiment. FIG. 5A shows the prescription smart label bottle 120 with affixed prescription smart label 100 and section lines defining the cross section in FIG. 5B of one embodiment.

### Flexible Rechargeable Flat Battery Recharging Circuit:

FIG. 5B shows for illustrative purposes only an example of a flexible rechargeable flat battery recharging circuit of one embodiment. FIG. 5B shows prescription smart label bottle 120 cross section including the prescription smart label 100. The energy induction coils 300 are used to charge the flexible rechargeable flat battery 270 by conducting energy from a nearby power source through a flexible rechargeable flat battery recharging circuit 500 of one embodiment.

### Med Weight Transducer:

FIG. 5C shows for illustrative purposes only an example of a med weight transducer of one embodiment. FIG. 5C shows prescription smart label bottle bottom view 520 of the energy induction coils 300 and a med weight transducer 510. The med weight transducer 510 senses and records the current weight of the contents including the weights of remaining pills. This data is transmitted to the smart label programmable memory device 130 where the current weight is used to compute the number of for example remaining pills using the data from the initial filling of the prescription at the pharmacy of one embodiment.

### Cap Ring Connector:

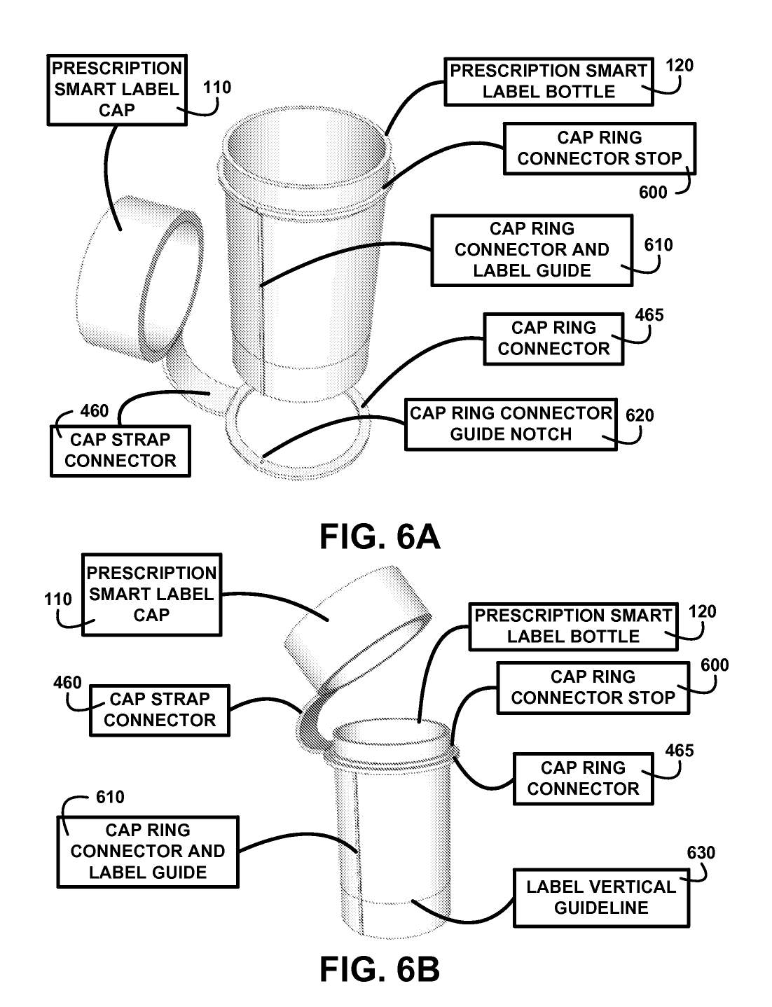

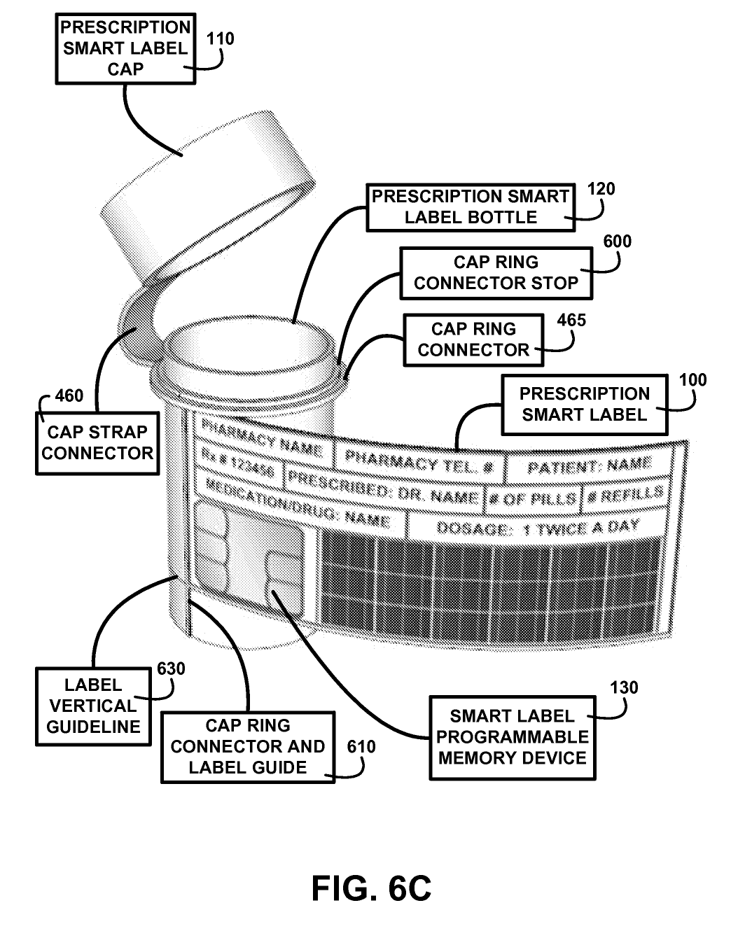

FIG. 6A shows for illustrative purposes only an example of a cap ring connector of one embodiment. FIG. 6A shows the prescription smart label bottle 120 including a cap ring connector and label guide 610 and cap ring connector stop 600. The cap ring connector stop 600 is use to stop the cap ring connector 465 from slipping off the top of the bottle. A cap ring connector guide notch 620 is used to position the cap ring connector 465 that is notch to match cap ring connector and label guide 610. The cap ring connector and label guide 610 is used to start the attachment of the prescription smart label 100 of FIG. 1 wherein the placement coincides with the internal features of the prescription smart label bottle 120 of one embodiment.

The internal features of the prescription smart label bottle 120 include side energy induction coils used to induce an energy field into the energy induction coils 300 of the prescription smart label 100 of FIG. 1 from induced power using the prescription smart label bottle 120 energy induction coils 300 located in the bottom of the bottle. Other circuits are installed in the cap ring connector 465 and run through the cap strap connector 460 to the prescription smart label cap 110 of one embodiment.

### Cap Ring Connector and Label Guide:

FIG. 6B shows for illustrative purposes only an example of a cap ring connector and label guide of one embodiment. FIG. 6B shows the prescription smart label bottle 120, cap ring connector stop 600 and a label vertical guideline 630 used in aligning the placement of the prescription smart label 100 of FIG. 1. The prescription smart label bottle 120 is shown including the cap ring connector and label guide 610. The prescription smart label cap 110 is shown including the cap strap connector 460 and cap ring connector 465 in position on the prescription smart label bottle 120 of one embodiment.

### Label Vertical Guideline:

FIG. 6C shows for illustrative purposes only an example of a label vertical guideline of one embodiment. FIG. 6C shows the prescription smart label cap 110, cap strap connector 460 and cap ring connector 465. The prescription smart label bottle 120 shows the cap ring connector stop 600 used to maintain the position of the cap ring connector 465. The prescription smart label 100 is being position for affixing using the label vertical guideline 630 and cap ring connector and label guide 610 to position the label features including the smart label programmable memory device 130 with the positions of the bottle internal features of one embodiment.

### Recharging Tray:

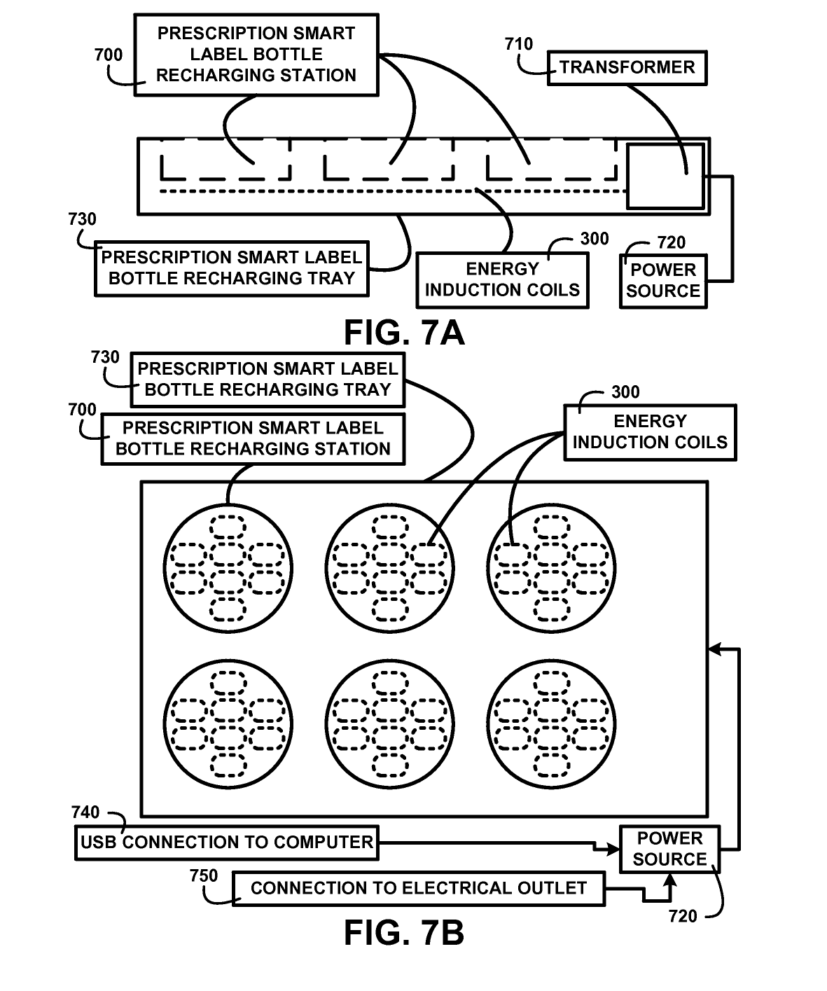

FIG. 7A shows for illustrative purposes only an example of a recharging tray of one embodiment. FIG. 7A shows cross section of a prescription smart label bottle recharging tray 730 including a connection to a power source 720 and a transformer 710 to feed energy to the energy induction coils 300. A prescription smart label bottle 120 of FIG. 1 can be placed in each prescription smart label bottle recharging station 700. The energy induction coils 300 located at the bottom of the prescription smart label bottle 120 receive power in the form of an electro-magnetic field and convert the field into electricity of one embodiment.

### Prescription Smart Label Bottle Recharging Tray:

FIG. 7B shows for illustrative purposes only an example of a prescription smart label bottle recharging tray of one embodiment. FIG. 7B shows plan view of the prescription smart label bottle recharging tray 730 including a power source 720 connection to electrical outlet 750 or a USB connection to computer 740. The power source 720 connections create a useable energy indirect energy current through the energy induction coils 300 in the prescription smart label bottle recharging station 700 for conversion to electricity in the prescription smart label bottle 120 of FIG. 1 of one embodiment.

### Prescription Smart Label Operations:

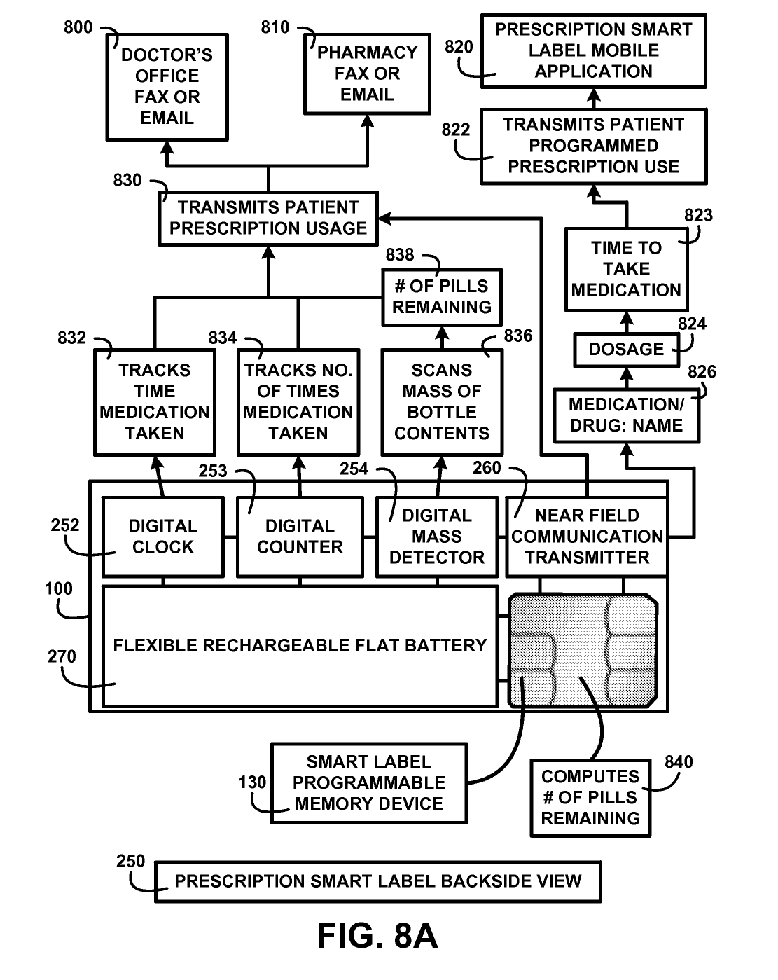

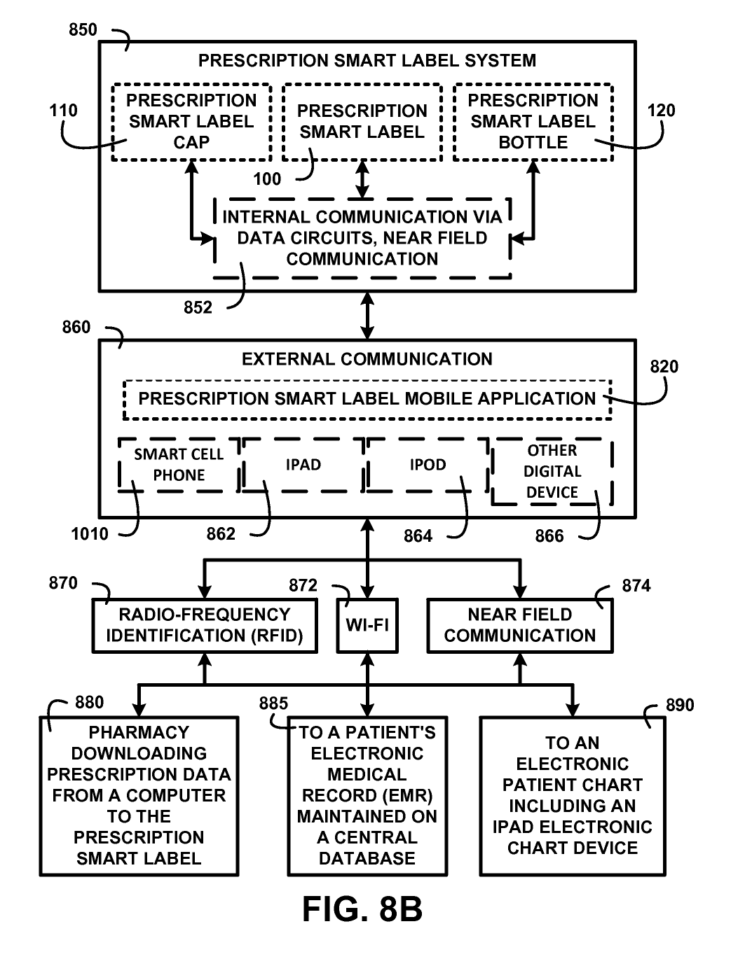

FIG. 8A shows a block diagram of an overview flow chart of prescription smart label operations of one embodiment. FIG. 8A shows a block diagram flow chart from the prescription smart label backside view 250 including the flexible rechargeable flat battery 270 used to power the smart label programmable memory device 130. The smart label programmable memory device 130 computes # of pills remaining 840 using the digital mass detector 254 and med weight transducer 510 of FIG. 5C. The digital mass detector 254 scans mass of bottle contents 836 including the # of pills remaining 838 of one embodiment.

The digital clock 252 tracks time medication taken 832 and the digital counter 253 tracks no. of times medication taken 834. The near field communication transmitter 260 is used to transmit reminders to the patient including the medication/drug: name 826, dosage 824 and time to take medication 823. The near field communication transmitter 260 transmits patient programmed prescription use 822 to for example a prescription smart label mobile application 820 for those times they may not be home. The near field communication transmitter 260 transmits patient prescription usage 830 to a doctor's office fax or email 800 to provide the doctor with an update on the status of the patient following the prescription. The near field communication transmitter 260 transmits to a pharmacy fax or email 810 as an alert on inventory of the patient's medication in anticipation of a refill of one embodiment.

### Prescription Smart Label Communications:

FIG. 8B shows a block diagram of an overview flow chart of prescription smart label communications of one embodiment. FIG. 8B shows the prescription smart label system 850 communications between the prescription smart label 100, prescription smart label cap 110, prescription smart label bottle 120 including Internal communication via data circuits, near field communication 852. The prescription smart label system 850 communications includes the prescription smart label mobile application 820 and with other external communication 860 digital devices including smart cell phone 1010, iPad 862, iPod 864 or other digital device 866. The prescription smart label 100, prescription smart label cap 110, prescription smart label bottle 120 communicate with external communication 860 digital devices including through the prescription smart label mobile application 820 using WiFi 872, Radio-frequency identification (RFID) 870, and near field communication 874. Examples of the communications include a pharmacy downloading prescription data from a computer to the prescription smart label 880 via Wi-Fi Direct. Another example is the transmitting of patient prescription and usage data from a patient smart cell phone, iPad, iPod or other digital device with the prescription smart label mobile application 820 installed to a patient's electronic medical record (EMR) maintained on a central database 885.

Yet another example is a doctor during a patient exam or during rounds at a hospital entering a prescription into a smart cell phone, iPad, iPod or other device wherein the patient's prescription data is automatically transmitted to a patient's EMR and simultaneously to an electronic patient chart including to an electronic patient chart including an iPad electronic chart device 890. The electronic patient chart may be used for patient treatment regimens in other settings including skilled nursing care, home care, and assisted living and thereby the most current prescriptions are downloaded via the automatic transmission to provide the health care personnel with up to date data immediately.

The integration of automated transmitting of the patient's prescription data into the patient EMR and electronic patient chart can include transmission to all of the doctors providing care to the patient. This provides a uniform database of the patient's prescription treatments to aid doctors on a coordinated basis in preventing drug conflicts.

### Pharmacy Preparation of Prescription Smart Label:

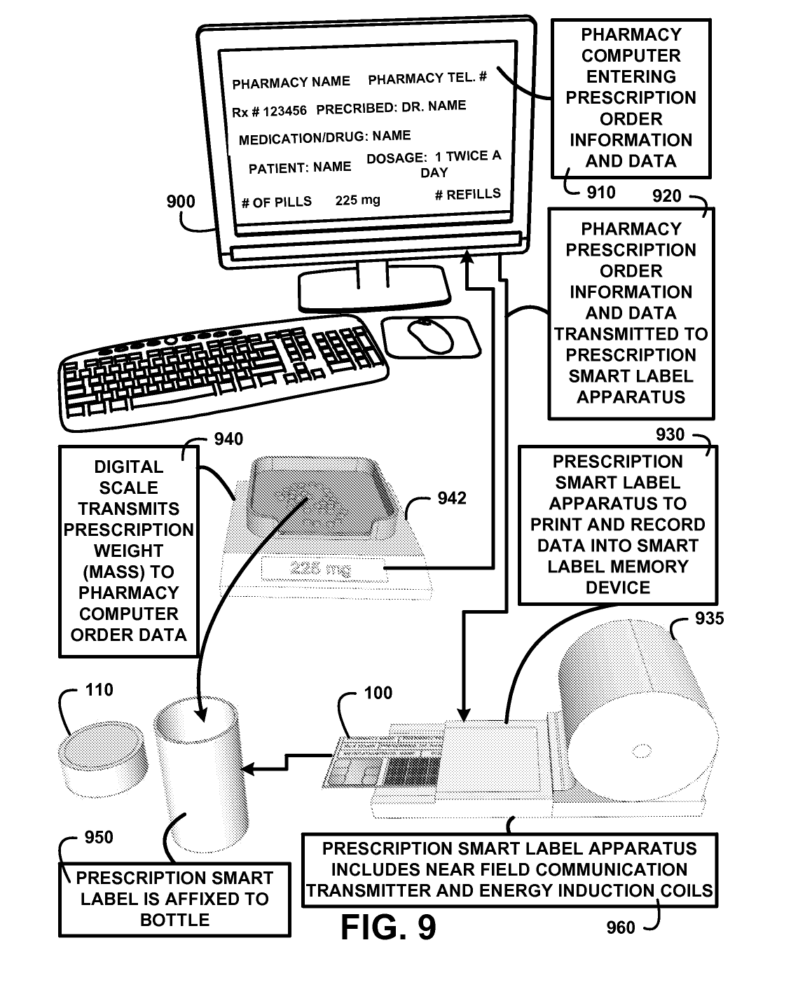

FIG. 9 shows for illustrative purposes only an example of a pharmacy preparation of prescription smart label of one embodiment. FIG. 9 shows pharmacy preparation of a prescription smart label 100 using a pharmacy computer entering prescription order information and data 910 on their computer 900 including the pharmacy name and/or logo, pharmacy tel. #, patient: name, Rx # 123456, prescribed: Dr. name, # of pills, # refills, medication/drug: name and dosage: 1 twice a day.

After or during entering pharmacy prescription order information and data transmitted to prescription smart label apparatus 920. The pharmacy can use a digital scale 942 when counting out for example the number of pills to fill the prescription. Before placing the pills into the prescription smart label bottle a digital scale transmits prescription weight (mass) to pharmacy computer order data 940 of one embodiment.

The pharmacist uses a prescription smart label apparatus to print and record data into smart label memory device 930. The flexible prescription smart labels can be fabricated on a roll and loaded into the prescription smart label apparatus 935. The apparatus can also be configured as a single feed label device. The prescription smart label apparatus includes near field communication transmitter and energy induction coils 960 to download the data and charge the label before the prescription smart label affixed to bottle 950 process begins of one embodiment.

### Prescription Smart Label Mobile Application:

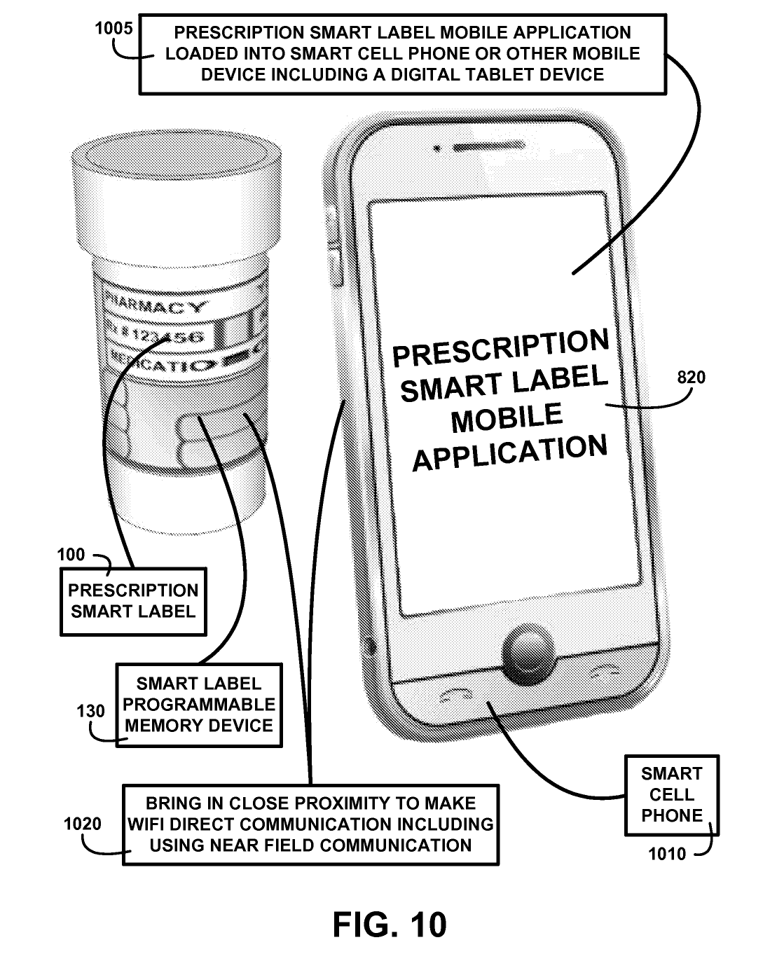

FIG. 10 shows for illustrative purposes only an example of a prescription smart label mobile application of one embodiment. FIG. 10 shows a prescription smart label mobile application 820 wherein the prescription smart label mobile application loaded into smart cell phone or other mobile device including a digital tablet device 1005. The smart cell phone 1010 is positioned to bring in close proximity to make Wi-Fi direct communication including using near field communication 1020 in the prescription smart label 100 and prescription data is downloaded from the smart label programmable memory device 130 of one embodiment.

### Automatically Locate Prescription Smart Label Bottle:

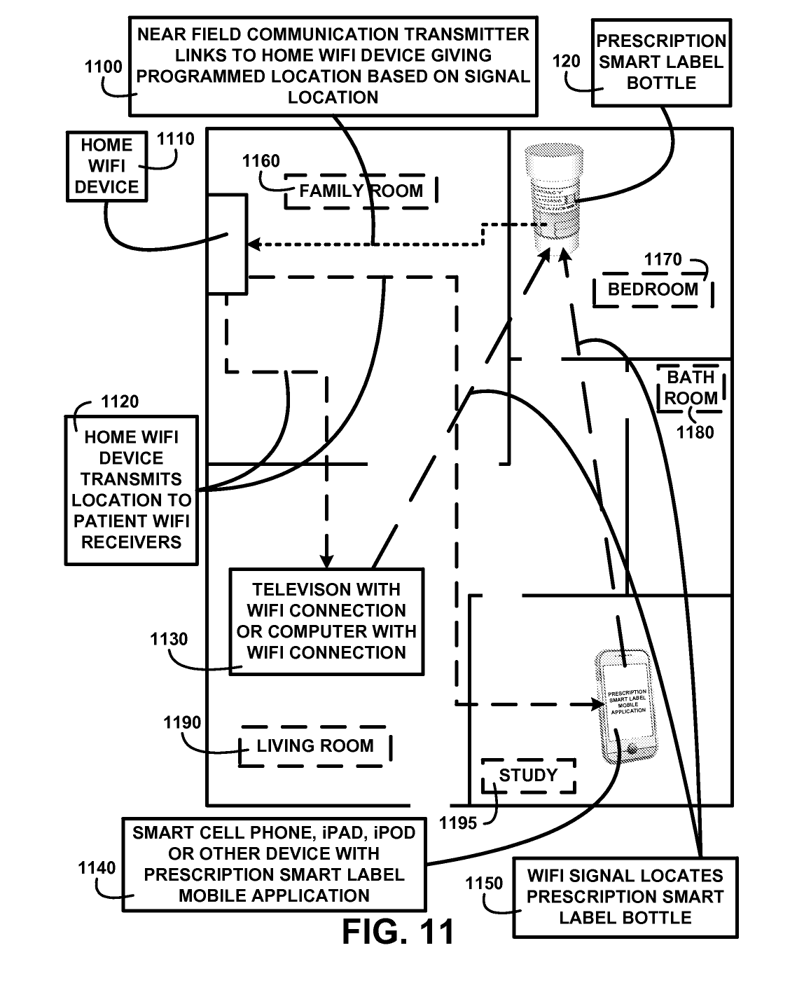

FIG. 11 shows for illustrative purposes only an example of an automatically locate prescription smart label bottle feature of one embodiment. FIG. 11 shows a feature used to automatically locate prescription smart label bottle 120 using a home Wi-Fi device 1110 for example in a family room 1160. A patient will get a reminder to take medication. The patient may not remember where they left the prescription smart label bottle 120. The home Wi-Fi device transmits location to patient Wi-Fi receivers 1120. The patient may be in the living room 1190 where they can get a location using a television with Wi-Fi connection or computer with Wi-Fi connection 1130.

The patient may be in the study 1195 when they get the reminder. The patient can use a smart cell phone, iPad, iPod or other device with prescription smart label mobile application 1140 to receive the reminder and location of the medication. The Wi-Fi signal locates prescription smart label bottle 1150 in the bedroom 1170 rather than the medicine cabinet in the bathroom 1180. The location of the prescription smart label bottle is determined using the near field communication transmitter 260 links to home Wi-Fi device 1110 giving programmed location based on signal location of one embodiment.

### Reusable Prescription Smart Label:

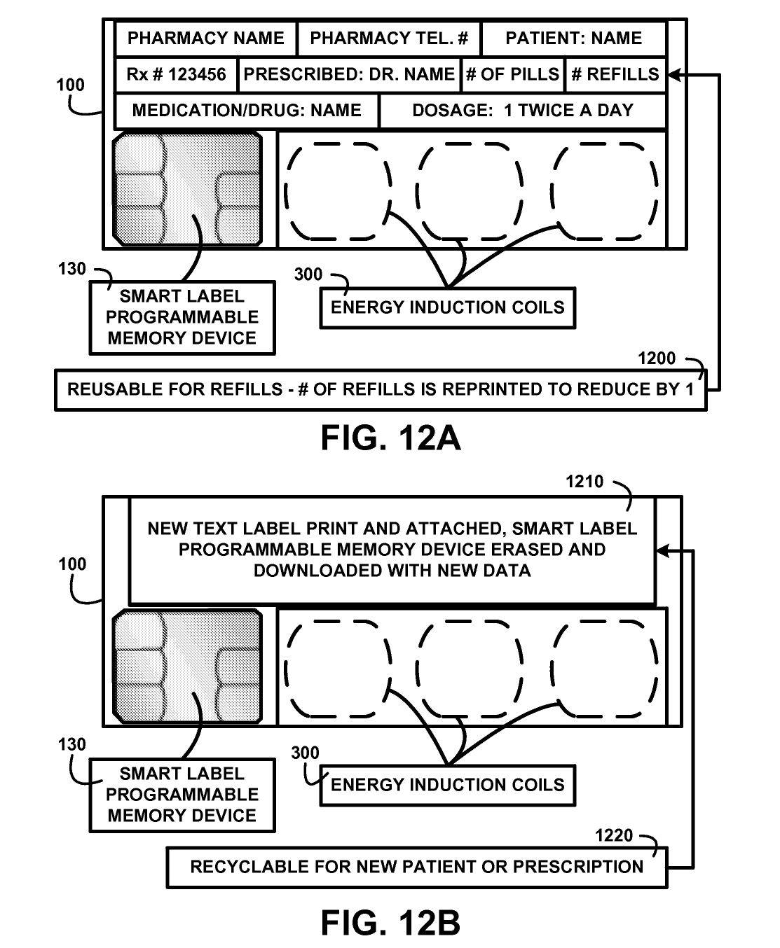

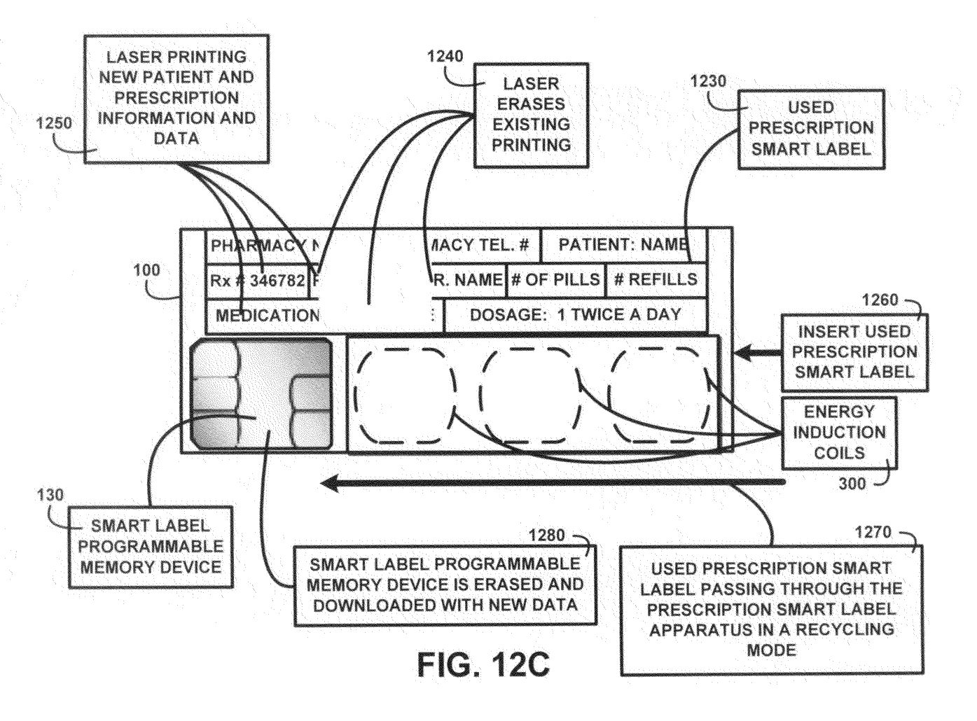

FIG. 12A shows for illustrative purposes only an example of a reusable prescription smart label of one embodiment. FIG. 12A shows the prescription smart label is reusable for refills—# of refills is reprinted to reduce by 1 1200 the number of refills available. The prescription smart label front side view shows the energy induction coils 300, smart label programmable memory device 130, pharmacy name and/or logo, pharmacy tel. #, patient: name, Rx # 123456, prescribed: Dr. name, # of pills, # refills to be adjusted and reprinted, medication/drug: name and dosage: 1 twice a day of one embodiment.

### Recyclable Prescription Smart Label:

FIG. 12B shows for illustrative purposes only an example of a recyclable prescription smart label of one embodiment. FIG. 12B shows a prescription smart label is recyclable for new patient or prescription 1220. The prescription smart label front side view shows where the patent information and prescription data has been erased. The energy induction coils and smart label programmable memory device 130 are not affected by the erasures. A new text label print and attached, smart label programmable memory device erased and downloaded with new data 1210. The prescription smart label may also be disposable. The patient can take the label to the pharmacy and have the personal information erased or use a simple magnet to erase the data on the smart label programmable memory device 130 of one embodiment.

### Label Apparatus Single Label Mode:

FIG. 12C shows for illustrative purposes only an example of a label apparatus single label mode of one embodiment. FIG. 12C shows the prescription smart label apparatus 935 of FIG. 9 can feature a single label mode to process a used prescription smart label 1230. The process begins by inserting a used prescription smart label 1230 into the prescription smart label apparatus 935 of FIG. 9. A used prescription smart label passing through the prescription smart label apparatus in a recycling mode 1270 is processed using the energy induction coils 300. A laser erases existing printing 1240 and is used for laser printing new patient and prescription information and data 1250. The smart label programmable memory device is erased and downloaded with new data 1280 of one embodiment.

### Fabrication Prescription Smart Label Cap:

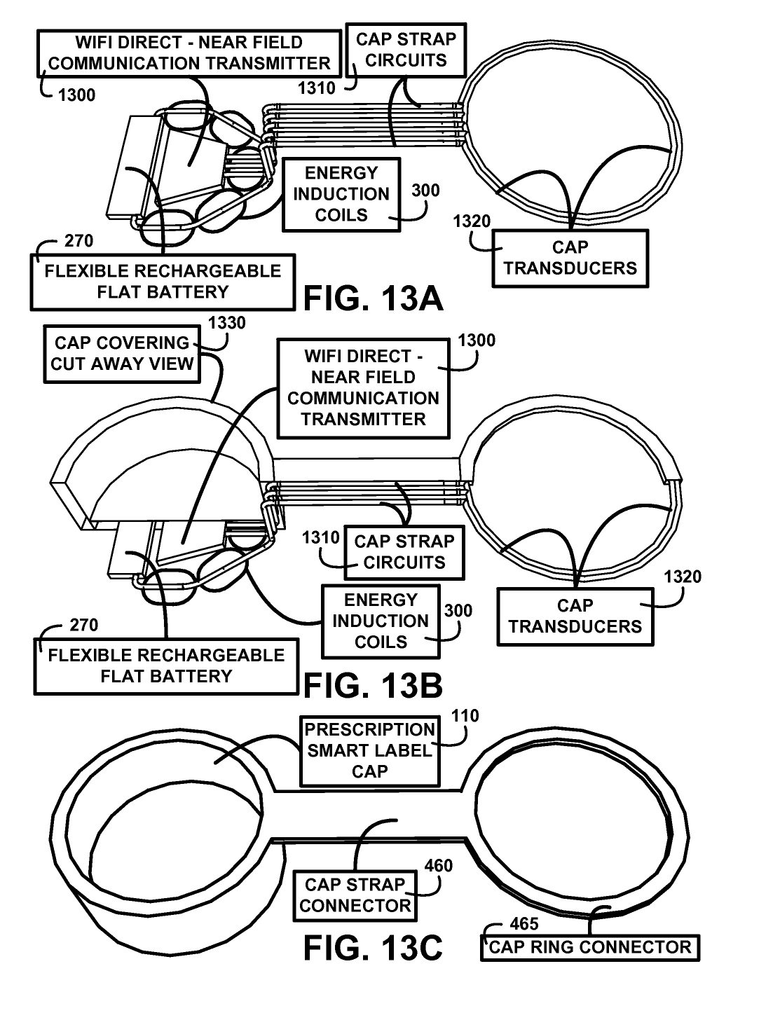

FIG. 13A shows for illustrative purposes only an example of a fabrication process of the prescription smart label cap of one embodiment. FIG. 13A shows a fabrication process to make the prescription smart label cap 110 of FIG. 1. The process begins wherein electronic devices and circuits are assembled including the energy induction coils 300, flexible rechargeable flat battery 270 and Wi-Fi direct—near field communication transmitter 1300. Circuits and other electronic parts including cap transducers 1320 and cap strap circuits 1310 are also assembled and attached to the electronic devices. The assembly is readied for placement into a mold to cover the parts and devices of one embodiment.

### Cap Covering Cut Away View:

FIG. 13B shows for illustrative purposes only an example of a cap covering cut away view of one embodiment. FIG. 13B shows a cap molding process used to create a covering encasing the electronic devices, circuits and transducers as shown in the cap covering cut away view 1330. The energy induction coils 300, flexible rechargeable flat battery 270, Wi-Fi direct—near field communication transmitter 1300, cap transducers 1320 and cap strap circuits 1310 are encased in a covering material including one or more plastic or other material of one embodiment.

### Prescription Smart Label Cap Molding Process:

FIG. 13C shows for illustrative purposes only an example of a prescription smart label cap molded of one embodiment. FIG. 13C shows the prescription smart label cap 110 molded for example using a rigid plastic including easy grip and child proof features. The cap strap connector 460 may be molded using a flexible plastic. The cap ring connector 465 may be molded using a flexible or rigid plastic of one embodiment.

### Fabricating the Prescription Smart Label Bottle:

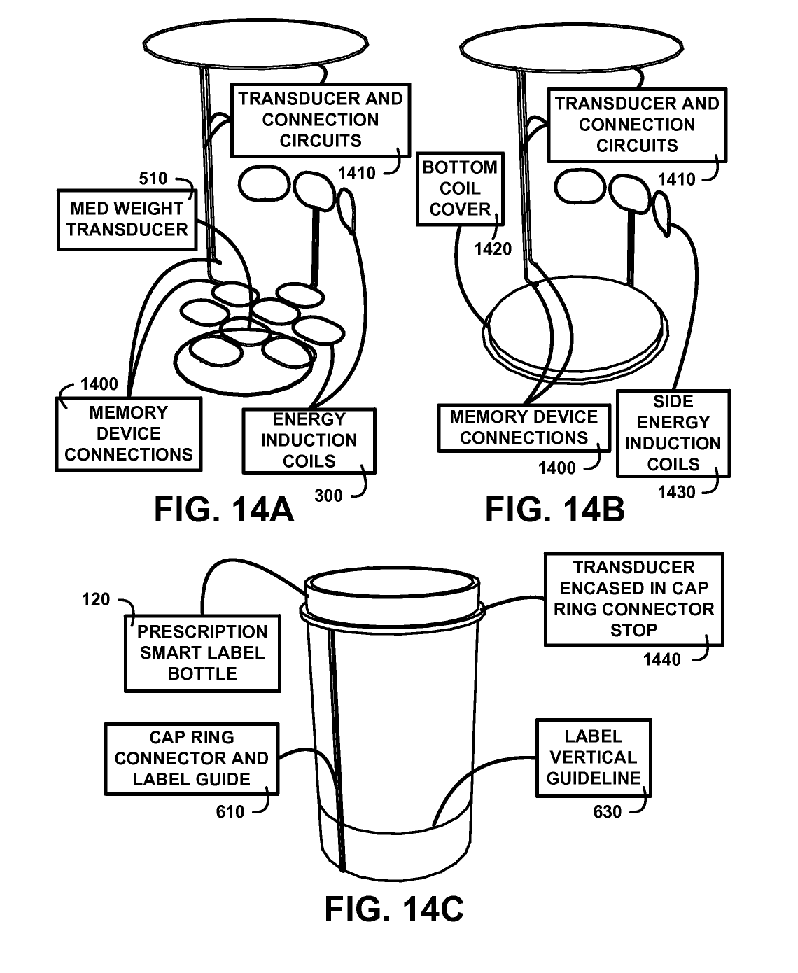

FIG. 14A shows for illustrative purposes only an example of a fabrication process of the prescription smart label bottle of one embodiment. FIG. 14A shows fabricating the prescription smart label bottle 120 of FIG. 1 including positioning of the energy induction coils 300 and med weight transducer 510 at the bottom of the bottle. Memory device connections 1400 including one or more transducer and connection circuits 1410 are included of one embodiment.

### Bottom Coil Cover:

FIG. 14B shows for illustrative purposes only an example of a bottom coil cover of one embodiment. FIG. 14B shows a bottom coil cover 1420 molded over the energy induction coils 300 and med weight transducer 510 at the bottom of the bottle. The bottom coil cover 1420 protects the devices and bottom circuits from damage by other processes and sets the position to prevent movement. The memory device connections 1400, transducer and connection circuits 1410 and side energy induction coils 1430 used to recharge the flexible rechargeable flat battery 270 of FIG. 2B located on the prescription smart label 100 of FIG. 1 are firmly positioned prior to the bottle body molding process of one embodiment.

### Prescription Smart Label Bottle Molding Process:

FIG. 14C shows for illustrative purposes only an example of a prescription smart label bottle molded of one embodiment. FIG. 14C shows the completed bottle molding process used to create the prescription smart label bottle 120. The mold is used to create the cap ring connector and label guide 610 and label vertical guideline 630. A transducer encased in cap ring connector stop 1440 is used for sensing medication including pills taken from the bottle or replaced. The transducer encased in cap ring connector stop 1440 is used to determine when the bottle is opened by sensing a distancing of the cap transducer.

The transducer encased in cap ring connector stop 1440 provides physical data used in determining and computing the current number of for example pills and the times and frequency a patient is taking their medication. This data is recorded in the smart label programmable memory device 130 using the memory device connections. The collected transducer data is processed to be transmitted to the patient, Doctor and pharmacy. Medication Therapy Management (MTM) is a service in pharmacy practice the includes reviewing the totality of a patients prescribed and over the counter medications on a coordinated basis with the patients doctors and pharmacies. Many patients go to different doctors for treatment of different conditions. While the patients are routinely asked about medications they are currently taking, this relies on the patient's ability to recall each medication, size of the dose and frequency. This becomes particularly difficult in elderly patients. The prescription smart label 100 bottle and cap system and prescription smart label mobile application 820 automates the reporting of the medications a patient is taking including a current list of the medications and frequency of taking and transmits that data to the pharmacies used for the prescriptions and all of the doctors prescribing medications. The coordination of the data availability allow doctors to be fully informed to prevents drug conflicts but also the efficacy of the medication when taken as a whole in the overall treatment of a patient of one embodiment.

### Prescription Smart Label Mobile Application Features:

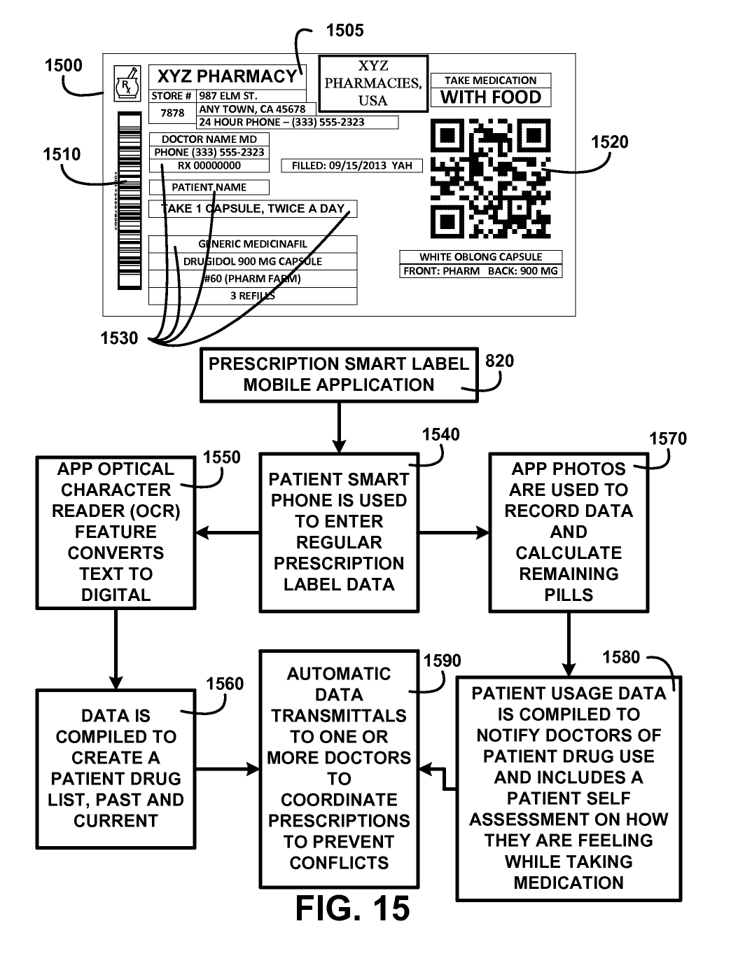

FIG. 15 shows for illustrative purposes only an example of a prescription smart label mobile application gathering prescription data from a regular prescription label of one embodiment. FIG. 15 shows a regular prescription bottle label 1500 including information about the pharmacy 1505, prescribing doctor, patient and prescription 1530, a barcode 1510 and a barcode configured as a QR code 1520. The prescription smart label mobile application 820 provides a means for a patient to input data from the regular prescription bottle label 1500 into their list of current medications. A patient smart phone is used to enter regular prescription label data 1540.

The prescription smart label mobile application 820 includes features including an app optical character reader (OCR) feature converts text to digital 1550. The application OCR feature is used to convert the regular prescription label data 1540 into digital text that can be used where data is compiled to create a patient drug list, past and current 1560. Automatic data transmittals to one or more doctors to coordinate prescription to prevent conflicts 1590 can protect the patient who may be unaware of potential drug conflicts. Additionally the prescription smart label mobile application 820 includes features including where app photos are used to record data and calculate remaining pills 1570 in a regular prescription bottle.

Patient usage data is compiled to notify doctors of patient drug use and includes a patient self-assessment on how they are feeling while taking medication 1580. This added data is included in automatic data transmittals to one or more doctors to coordinate prescriptions to prevent conflicts 1590. The patient prescription and usage data is compiled in a patient EMR in a central database. The compiled data can be combined with other patient data on a non-identified basis protecting the patient privacy and used to create a comparison with test data for the same prescription medication including mental health and DNA/genetic research. The comparisons can include whether based on patient usage and reactions the doses are over, under or proper dosage levels and whether the particular prescription medication is suitable for other treatments including mental health or should be more tightly controlled for the diagnosed condition as the cumulative results show a negative reaction for example above or below a range of doses, or general use at any dosage. The prescription smart label system data collection feature provides an opportunity to gather data on a wide scale basis under actual patient use conditions into order to form an accurate database of medication use and effectiveness of one embodiment.

### Prescription Smart Label Mobile Application Photo Data Features:

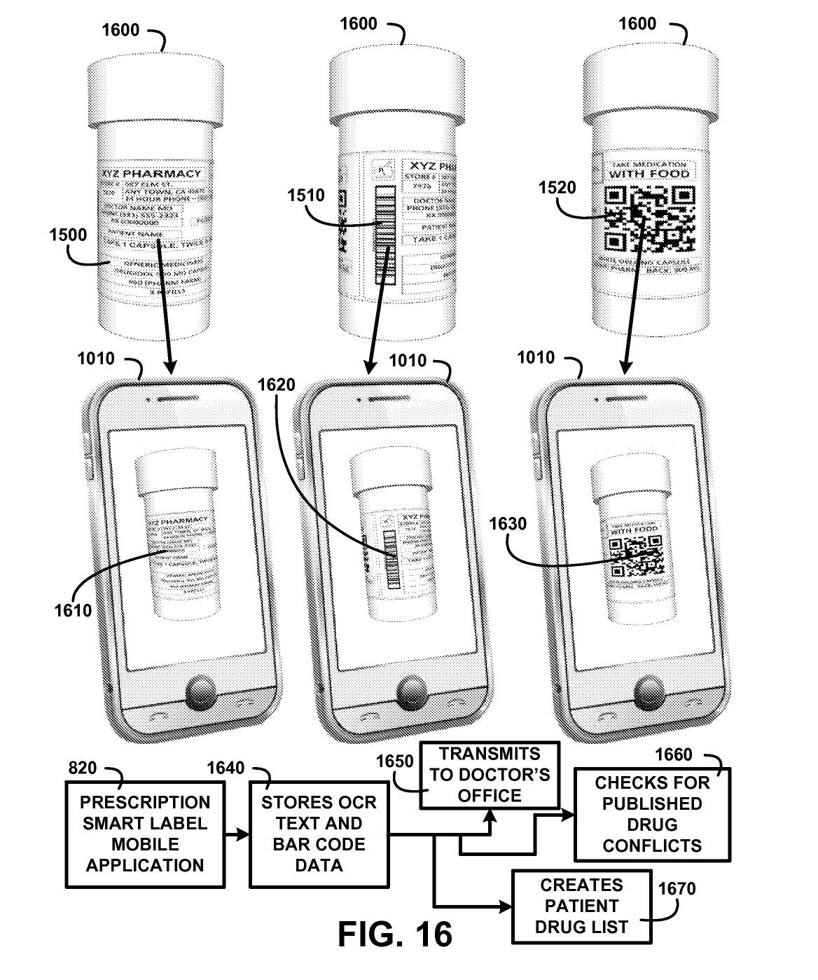

FIG. 16 shows for illustrative purposes only an example of a prescription smart label mobile application taking photos of regular prescription label to OCR to gather data of one embodiment. FIG. 16 shows a patient smart phone device 1010 being used to take photos of a regular prescription bottle label 1500 on a regular prescription bottle 1600 using the prescription smart label mobile application 820. The label photo 1610 is processed using the app optical character reader (OCR) feature converts text to digital 1550 of FIG. 15 to create digital text data written on the regular prescription bottle label 1500. The prescription smart label mobile application 820 can also be used to take photos of the typical barcode 1510 and QR code 1520. The prescription smart label mobile application 820 features includes a barcode reader that can decipher the coded information from the barcode photo 1620 and QR code photo 1630 and perform a search for the data contained within the codes. The prescription smart label mobile application 820 stores OCR text and bar code data 1640 and appends or creates patient drug list 1670. The prescription smart label mobile application 820 transmits to doctor's office 1650 the patient drug list. The prescription smart label mobile application 820 can perform checks for drug conflicts 1660 to provide an initial alert to the doctors of one embodiment.

### Prescription Smart Label Mobile Application Photo Timer Cap Features:

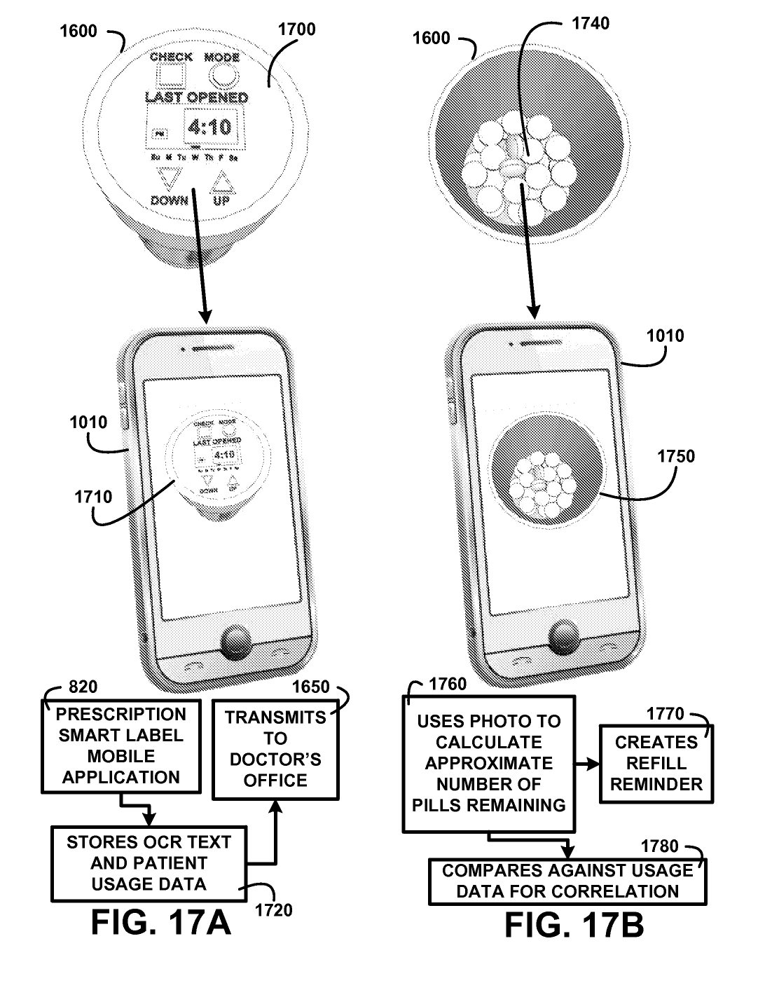

FIG. 17A shows for illustrative purposes only an example of a prescription smart label mobile application taking photos of a timer cap to gather patient medication usage data of one embodiment. FIG. 17A shows the patient smart cell phone 1010 with the prescription smart label mobile application 820 being used to take a photo of a timer cap 1700. The timer cap photo 1710 is processed using the app optical character reader (OCR) feature to convert the information from the photo into digital text including time and day last opened. The prescription smart label mobile application 820 stores OCR text and patient usage data 1720 and automatically transmits to doctor's office 1650 the patient usage data of one embodiment.

### Prescription Smart Label Mobile Application Photo Pill Count Features:

FIG. 17B shows for illustrative purposes only an example of a prescription smart label mobile application taking photos of remaining pills to gather patient medication usage data of one embodiment. FIG. 17B shows the patient smart cell phone 1010 with the prescription smart label mobile application 820 being used to take a photo of the pills remaining 1740 in the bottle. the prescription smart label mobile application 820 is used to determine the content of photographic images. The pills remaining photo 1750 is processed using an the prescription smart label mobile application 820 photo pill count features to wherein the application uses photo to calculate approximate number of pills remaining 1760.

The prescription label data on the medication include size and form of the medication i.e. round tablet, capsule, or another shape. The prescription smart label mobile application 820 determines the volumetric space occupied by the remaining pills using depth in bottle, diameter which can be approximated based on the size of the pill image, typical free space between pills of that size and shape when confined and can determine an approximation of the number of pills remaining in the bottle. The pill remaining determination and original number of pills for the prescription creates refill reminder 1770 for the patient and notifies the filling pharmacy of the pending refill order.

The prescription smart label mobile application 820 uses the difference in the number of pills in the original prescription less the remaining pills and the time elapsed from the prescription fill date and compares against usage data for correlation 1780, including timer cap 1700 data and other data. This information is automatically transmitted to the doctor's office to provide an additional measure on the patient adherence to dosage instructions. The same information is displayed for the patient using the prescription smart label mobile application 820 to alert the patient on their actual use of the medication to assist them in maintaining a prescribed regimen of one embodiment.

The foregoing has described the principles, embodiments and modes of operation of the present invention. However, the invention should not be construed as being limited to the particular embodiments discussed. The above described embodiments should be regarded as illustrative rather than restrictive, and it should be appreciated that variations may be made in those embodiments by workers skilled in the art without departing from the scope of the present invention as defined by the following claims.

What is claimed is:

1. A prescription smart label system for tracking patient use of prescription medications to assist in medication treatment to monitor their progress toward recovery or health maintenance, comprising:
a prescription smart label including a text section with prescription information, a smart label programmable memory device, one or more rechargeable battery systems, other digital devices and Wi-Fi direct near field communication transmitter used to transmit patient prescription use;
a prescription smart label cap including one or more systems to remind patients of prescription use times and dosages;
a prescription smart label bottle including one or more systems used to monitor the physical use of the patient prescription medication and monitor the contents of the prescription smart label bottle; and
a prescription smart label mobile application used to gather, record, store and transmit patient patient prescription use data.

2. The system of claim 1, further comprising a prescription smart label including a flexible photo/light power converter including a solar cell array, a device for converting light of infrared (IR) and visible wavelengths into direct current and rectennas using long-wavelength light including microwaves and radio waves.

3. The system of claim 1, further comprising a prescription smart label including a smart label programmable memory device to store information and data including a pharmacy name, pharmacy name and telephone number, a patient name, prescription number, prescribing doctors name, the number of pills filled, number of refills, medication/drug name and strength, size and type of pill, and dosage instructions.

4. The system of claim 1, further comprising a prescription smart label including digital devices including a flexible rechargeable flat battery, a digital clock device to record when a patient takes medication, a digital counter device to count and record the number of times the bottle is opened, and a digital mass detector to scan the volume and mass of the contents of the bottle.

5. The system of claim 1, further comprising a prescription smart label including downloadable information and data accessible stored onto a mobile device with the prescription smart label mobile application including a smart cell phone in proximity with the prescription smart label.

6. The system of claim 1, further comprising a prescription smart label cap including a prescription smart label cap projector configured to project a dosage text reminder image and including a lens, a projector, adjustable colors, time zone and format selectable language settings and an audio alarm configured to include announce a dosage reminder and including a text to voice reader, a selection of alarm sounds and selectable language settings and including a cap strap connector and a cap ring connector.

7. The system of claim 1, further comprising a prescription smart label bottle including a flexible rechargeable flat battery recharging circuit, energy induction coils a med weight transducer configured to sense and record the current weight of the contents including the weights of remaining pills, a label vertical guideline, and a cap ring connector and label guide.

8. The system of claim 1, further comprising a prescription smart label mobile application including features configured to automatically locate a prescription smart label bottle using a Wi-Fi device and near field communication transmitter.

9. The system of claim 1, further comprising a prescription smart label mobile application including features including an optical character reader to convert images to digital text, a barcode reader configured to read barcodes including QR codes from a photo and perform a search of data contained in those codes.

10. The system of claim 1, further comprising a prescription smart label mobile application including features configured to determine the number of remaining pills in a bottle using a photo of the pills in the bottle.

11. An apparatus comprising:
a prescription smart label apparatus including a near field communication transmitter/receiver, at least one energy induction coil, a laser printer. and a flexible prescription smart label roll feed;
a single prescription smart label mode; and
a recycling mode including a laser eraser to erase existing text.

12. The apparatus of claim 11, wherein the apparatus is configured to print text on a prescription smart label.

13. The apparatus of claim 11, wherein the apparatus is configured to download prescription data onto a smart label programmable memory device.

14. The apparatus of claim 11, further comprising an interface configured to receive prescription data from an external source digital data transmission including WiFi, Radio-frequency identification (RFID), and near field communication.

15. A prescription smart label mobile application system comprising:
at least one group of digital codes to receive and transmit data using a digital device;
at least one group of digital codes to capture, record and determine the content of photographic images; and
at least one group of digital codes to convert images into digital text.

16. The system of claim 15, further comprising a prescription smart label including downloadable information and data accessible stored onto a mobile device with the prescription smart label mobile application including a smart cell phone in proximity with the prescription smart label.

17. The system of claim 15, further comprising a prescription smart label mobile application including features configured to automatically locate a prescription smart label bottle using a Wi-Fi device and near field communication transmitter.

18. The system of claim 15, further comprising a prescription smart label mobile application including features including an optical character reader to convert images to digital text, a barcode reader configured to read barcodes including QR codes from a photo and perform a search of data contained in those codes.

19. The system of claim 15, further comprising a prescription smart label mobile application including features configured to determine the number of remaining pills in a bottle using a photo of the pills in the bottle.

20. The system of claim 15, further comprising at least one group of digital codes configured to operate on at least one smart cell phone format, on at least one tablet format including an iPad, on at least one hand held digital device format including an iPod or other digital devices and formats.
